(19) United States
(12) Patent Application Publication
(10) Pub. No.: US 2026/0254853 A1
(43) Pub. Date: Aug. 27, 2026

(54) ADAPTIVE HONEYPOT GENERATION USING FINE-TUNED GENERATIVE ARTIFICAL INTELLIGENCE

(71) Applicant: DELL PRODUCTS L.P., Round Rock, TX (US)

(72) Inventors: Parminder Singh Sethi, Ludhiana (IN); Avinash Kumar, Patna (IN); Praveen Kumar, Noida (IN)

(21) Appl. No.: 19/065,193

(22) Filed: Feb. 27, 2025

(51) Int. Cl. H04L 9/40

(52) U.S. Cl. CPC H04L 63/1491; H04L 63/1416

(57) ABSTRACT

A system for countering ransomware attacks includes a honeypot deployment controller configured to deploy a honeypot within an enterprise environment. The honeypot is generated by a generative artificial intelligence (AI) model trained on a predetermined risk profile. The honeypot is generated to attract ransomware attackers. The system includes a ransomware threat analyzer communicatively coupled with the honeypot deployment controller. The ransomware threat analyzer is configured to respond to a ransomware attack by classifying the ransomware attack and generating a recommendation based on the classifying. The system includes a security management interface communicatively coupling the ransomware threat analyzer with a security management system for the enterprise environment. The security management interface is configured to convey the recommendation to the security management system.

### FIELD OF THE DISCLOSURE

The present disclosure generally relates to information handling systems, and more particularly relates to protecting information handling systems from ransomware attacks.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A system for countering ransomware attacks includes a honeypot deployment controller configured to deploy a honeypot within an enterprise environment. The honeypot is generated by a generative artificial intelligence (AI) model trained on a predetermined risk profile. The honeypot is generated to attract ransomware attacks. The system includes a ransomware threat analyzer communicatively coupled with the honeypot deployment controller. The ransomware threat analyzer is configured to respond to a ransomware attack by classifying the ransomware attack and generating a recommendation based on the classifying. The system includes a security management interface communicatively coupling the ransomware threat analyzer with a security management system for the enterprise environment. The security management interface is configured to convey the recommendation to the security management system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an enterprise environment including multiple information handling systems and a honeypot deployment and threat assessment (HDTA) framework according to an embodiment of the present disclosure;

FIG. 2 is a block diagram of an exemplary architecture of the HDTA framework according to an embodiment of the present disclosure;

FIG. 3 is a flow diagram of a method for deploying one or more honeypots to attract a ransomware attack and for analyzing data generated by the honeypot(s) in response to a ransomware attack according to an embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

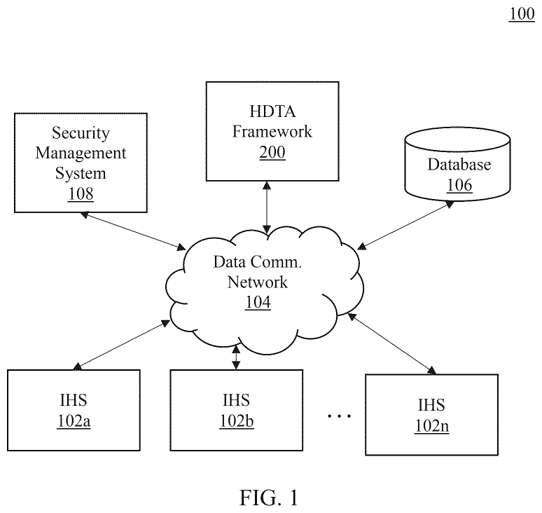

FIG. 1 is a block diagram of an enterprise environment 100 having an information technology (IT) infrastructure that includes multiple information handling systems 102a and 102b through 102n (where n is a positive integer) interconnected via a data communications network 104 (e.g., local area network (LAN) or wide area network (WAN)). For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Many information handling systems and the data used with such systems making up an enterprise environment face an ever-present threat of cyberattack. On type of cyberattack is a ransomware attack, which seeks to the infect the information handling systems with malicious software (ransomware) designed to block access to the information handling systems or data until a ransom is paid. Ransomware attackers often follow goal-oriented strategies that typically involve a sequence of well-planned actions designed to maximize the likelihood of successfully extorting payment to unblock access to the information handling systems or data. A strategy may involve attempting to identify vulnerabilities in the systems and attempting to gain access by exploiting an identified vulnerability, culminating in the deployment of ransomware on the information handling systems of the enterprise environment. A significant challenge to any effort to prevent ransomware attacks is the fact that the goal-oriented strategies pursued by the attackers frequently evolve and may change depending on the specific target.

Referring still to FIG. 1, enterprise environment 100 also includes a honeypot deployment and threat assessment (HDTA) framework 200. HDTA framework 200 is capable of generating a diverse set of honeypots customized to the specific vulnerabilities of enterprise environment 100. Operatively, HDTA framework 200 is configured to classify different types of ransomware and the nature of the threats posed by each. HDTA framework 200 is configured to classify ransomware by performing pattern recognition using a machine learning model trained with an extensive corpus of known ransomware behaviors and variations stored in database 106. The resulting classifications provide input to a generative artificial intelligence (AI) model, which is prompted to generate one or more honeypots customized to attract and detect specific types of ransomware used in a ransomware attack. HDTA framework 200 is further configured to analyze the threats posed by detected ransomware and to generate a recommendation tailored to the threat. In some embodiments, HDTA framework 200 is configured to convey the recommendation to security management system 108 of enterprise environment 100.

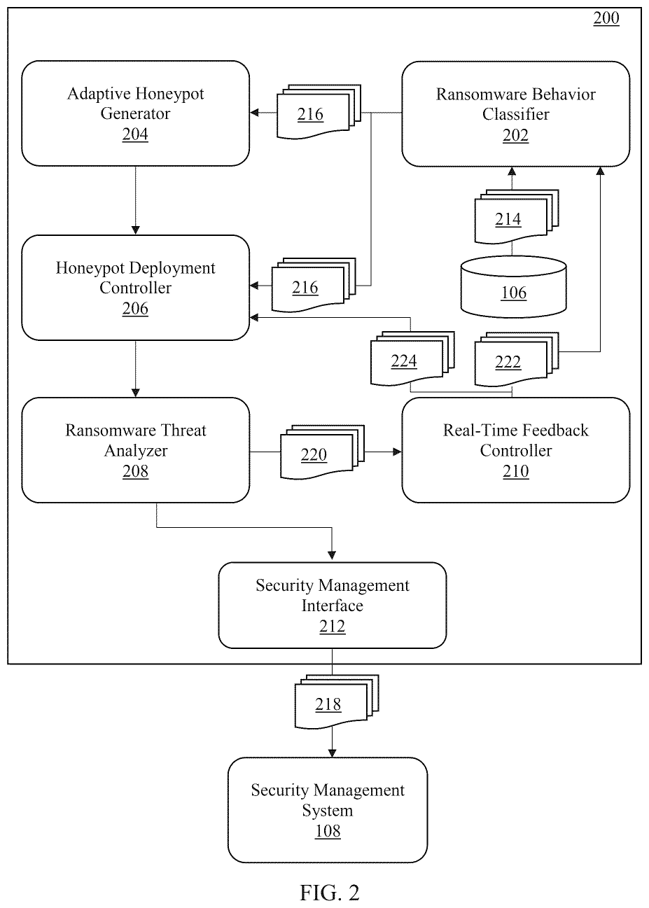

FIG. 2 illustrates an exemplary architecture of HDTA framework 200. In the exemplary architecture of FIG. 2, HDTA framework 200 illustratively includes ransomware behavior classifier 202, adaptive honeypot generator 204 coupled with the ransomware behavior classifier, and honeypot deployment controller 206 coupled with both the adaptive honeypot generator and ransomware behavior classifier. HDTA framework 200 also illustratively includes ransomware threat analyzer 208 coupled with honeypot deployment controller 206, and real-time feedback controller 210 coupled with the ransomware threat analyzer and ransomware behavior classier 202 for feeding data generated by the ransomware threat analyzer back to the ransomware behavior classifier. Illustratively, HDTA framework 200 also includes security management interface 212, which connects ransomware threat analyzer 208 with security information system 108 of enterprise environment 100. Security management system 108 may be a security information and event management (SIEM) system, which combines security information functions and security event management functions into a single system. Security management interface 212 may be implemented as an application programing interface (API) gateway for managing and monitoring API traffic between security management system 108 and HDTA framework 200.

In certain embodiments, the components of HDTA framework 200 may be implemented in processor-executable instructions (software) that run on an information handling system such as information handling system 400 described with respect to FIG. 400. In other embodiments, the components of HDTA framework 200 may be implemented in application-specific circuitry (hardware), with the components operatively coupled with one another. In yet other embodiments, the components of HDTA framework 200 may be implemented in a combination of software and hardware.

Ransomware behavior classifier 202 is configured to generate, based on ransomware behavior data 214, one or more risk profiles 216. Ransomware behavior classifier 202 generates a risk profile based on recognizing behavioral patterns within ransomware behavior data 214 stored in database 106. In certain embodiments, ransomware behavior data 214 is a select set of data generated in response to prior ransomware attacks using specific ransomware targeting enterprises or organizations similar to or within the same area of endeavor (e.g., a specific type of industry) as enterprise environment 100. Behavior classifier 202 recognizes behavioral patterns and variations in the patterns generated by different ransomware based on ransomware behavior data 214 generated in response to prior ransomware attacks. Behavioral patterns may be recognized by ransomware behavior classifier 202 from ransomware behavior data 214 such as execution logs, payload signatures (e.g., data content transferred in a network packet or data structure), and/or other data corresponding to a ransomware attack.

The behavioral patterns recognized by ransomware behavior classifier 202 may reveal, for example, encryption mechanisms used by an attacker, including file types, algorithms, and execution sequences that prevent access to data and systems of an enterprise environment until a ransom is paid. Ransomware behavior classifier 202 may recognize behavioral patterns regarding lateral movements by an attacker performing reconnaissance for network vulnerabilities of a data communications network, or by an attacker that has already breached the network perimeter of the data communications network. With respect to an attacker that has already breached the network perimeter, the lateral movements recognized by ransomware behavior classifier 202 may real the attacker's behavior for spreading ransomware from the entry location throughout the data communications network, including performing credential harvesting using malicious extensions.

Another behavioral pattern recognized by ransomware behavior recognizer 202 is the level of sophistication of different ransomware. Ransomware behavior classifier 202, in certain embodiments, is configured to distinguish between opportunistic ransomware and targeted ransomware. Behavioral patterns associated with the former may include exploiting common vulnerabilities. Behavioral patterns associated with the latter may include advanced persistent threats (APTs) using zero-day and similar type vulnerabilities, advanced lateral movements to breach network security, registry alterations, hidden executables, and/or rootkit malware.

In certain embodiments, ransomware behavior classifier 202, is configured to implement a machine learning model trained to perform pattern recognition to recognize the behavioral patterns corresponding to previous ransomware attacks. Ransomware behavior classifier 202, in some embodiments, may implement a deep neural network trained to perform pattern recognition. The deep neural network may be trained on a corpus of data corresponding to ransomware attacks, the corpus of data stored in database 106 as training data. The deep neural network, in some embodiments, may be trained through supervised learning on features extracted form ransomware behavior data 214 and preprocessed for input to the model In other embodiments, ransomware behavior classifier 202 may implement other types of machine learning models such as k-nearest neighbors, a support vector machine (SVM), or decision tree trained to recognize ransomware behavioral patterns.

Ransomware behavior classifier 202 generates risk profile(s) 216 based on recognized patterns of behavior of prior ransomware attacks. In certain embodiments, risk profile(s) 216 are industry-specific profiles. Risk profile(s) 216 that are industry-specific reflect the observation that in many cases the nature of a ransomware attack depends on the type of industry that enterprise environment 100 is associated with. For example, if risk profile(s) 216 are specific to the healthcare industry (e.g., hospital), the behavioral patterns on which the profiles are based are likely to reveal how ransomware that is used to attack healthcare providers is designed for encrypting electronic health records (EHRs) of the healthcare providers'patients. If risk profile(s) 216 are based on behavioral patterns associated with ransomware attacks on manufacturing entities, by contrast, the patterns likely reveal how ransomware that is used to attack a manufacturing entity is designed for disrupting production lines and production-related systems and devices. If, for example, risk profile(s) 216 are based on the behavioral patterns of ransomware attacks on financial institutions, the behavioral patterns on which the risk profile(s) are based are likely to reveal how ransomware is designed for encrypting transactional systems (e.g., ATMs) and/or stealing customer's sensitive financial data.

Adaptive honeypot generator 204 is configured to train a generative AI model based on risk profile(s) 216, which have been generated by ransomware behavior classifier 202 and conveyed to adaptive honeypot generator 204 as well as to ransomware threat analyzer 208. In certain embodiments, adaptive honeypot generator 204 is configured to train the generative AI model through supervised learning with compiled data extracted from risk profile(s) 216. Once trained, the generative AI model generates one or more honeypots for deployment within enterprise environment 100 via data communication network 104.

The generative AI model trained by adaptive honeypot generator 204 is, in certain embodiments, a generative AI model having a transformer architecture. Adaptive honeypot generator 204 may be configured to train the generative AI model as a transformer with features extracted from risk profile(s) 216. The features may be preprocessed and input to the transformer model. The features are fed through the transformer, layer by layer, to generate an output (honeypot) that is compared to an existing honeypot that serves as a training example. How accurate the model-generated honeypot is to the one serving as a training example can be measured by a loss function, and the measure backpropagated through the model based on gradients calculated with respect to each parameter of the model. An optimization algorithm may update the parameters, with the process repeating through several epochs until the generative AI model is adequately trained. Once trained, the generative AI model may be prompted to generate an original honeypot that is likely to attract a ransomware attack and successfully deceive the attacker so that the attack may be analyzed. The prompting may prompt the generative AI model to generate a honeypot that comprises a deceptively realistic false file system and credentials, a simulated network environment, vulnerabilities that mimic high-value assets of the enterprise environment, and/or other decoy that mimics a system or service of enterprise environment 100.

In other embodiments, adaptive honeypot generator 204 may be configured to train generative AI models having different architectures. The architecture of the generative AI model implemented by adaptive honeypot generator 204, in some embodiments, may be a generative adversarial network (GAN). The GAN is formed from two neural networks: a generator and a discriminator. The generator tries to generate a honeypot that is deceptively like the training examples; the discriminator tries to tell whether the honeypot is one generated by the generator or a genuine one (training example). Through competition between the generator and discriminator, the GAN learns to generate honeypots through unsupervised learning. Other generative AI models having different architectures, such as variational autoencoders (VAEs), may be implemented by adaptive honeypot generator 204 in other embodiments.

Honeypot deployment controller 206 is configured to deploy within enterprise environment 100 the one or more honeypots generated by adaptive honeypot generator 204 and conveyed to the honeypot deployment controller. Additionally, risk profile(s) 216 are conveyed to honeypot deployment controller 206 by ransomware behavior classifier 202 and, based on the risk profile(s), honeypot deployment controller 206 determines where within enterprise environment 100 to deploy the honeypot(s). Honeypot deployment controller 206 deploys the honeypot(s) based on risk profile(s) 216 to locations that optimize the likelihood of attracting and detecting a ransomware attack. A honeypot may be deployed by honeypot deployment controller 206 on the perimeter of data communications network 104 to attract and identify a ransomware attacker attempting to breach the network's security. Honeypot deployment controller 206 may deploy a honeypot within the internal portion of data communications network 104 to identify internal ransomware threats and lateral movements by a ransomware attacker that has successfully breached the perimeter. Based on risk profile(s) 216, one or more honeypots may be deployed by honeypot deployment controller 206 within a demilitarized zone (DMZ), which is a physical or logical subnet that separates information handling systems 102a-102n from any untrusted network (e.g., the Internet).

Honeypot deployment controller 206 may deploy different honeypots generated by adaptive honeypot generator 204 to different locations within data communications network 104 of enterprise environment 100. Each honeypot deployed may be specifically configured based on risk profile(s) 216 to mimic different types of systems and services. For example, one honeypot may deceptively appear as a vulnerable database storing proprietary or sensitive information, and another honeypot may deceptively appear as a vulnerable web-based server.

Ransomware threat analyzer 208 is configured to respond to a ransomware attack by classifying the ransomware attack and generating recommendation 218, the recommendation based on the classifying of the ransomware attack. Ransomware threat analyzer 208 performs the classifying of the ransomware attack by implementing a machine learning classifier trained through machine learning to classify ransomware attacks based on data generated by the one or more deployed honeypots in response to the ransomware attack. Ransomware threat analyzer 208 may be configured to classify the ransomware attack based in part on a combination of which of the one or more honeypots were triggered and the sequence in which each was triggered in response to the ransomware attack.

Recommendation 218 generated based on ransomware threat analyzer 208's classifying the ransomware attack, may recommend one or more ways for countering the ransomware attack. Accordingly, recommendation 218 is conveyed via security management interface 212 to security management system 108 of enterprise environment 100. Ransomware threat analyzer 208, in certain embodiments, may be configured to also convey honeypot-generated data 220 generated by the one or more honeypots in response to the ransomware attack to real-time feedback controller 210. Real-time feedback controller 210 is configured to parse honeypot-generated data 220 received from ransomware threat analyzer 208 and to generate parsed data 222, which may be conveyed in real time to ransomware behavior classifier 202. Ransomware behavior classifier 202 may be configured to update risk profile(s) 216 generated based on ransomware behavior data 214 by updating the risk profile(s) with parsed data 222. The updating may be performed in real time. Risk profile(s) 216 which are updated by ransomware behavior classifier 202 based on parsed data 222 may also be conveyed to adaptive honeypot generator 204 and to honeypot deployment controller 206 for creating and deploying one or more newly configured honeypots. The creating and deploying the newly configured honeypot(s) likewise may be performed in real time.

In certain embodiments, real-time feedback controller 210 communicatively couples with honeypot deployment controller 206 and is configured to operate as a deception feedback module. In response to a ransomware attack, feedback controller 210 operating as a deception feedback module may continuously, or semi-continuously, feedback to honeypot deployment controller 206 data 224, the data generated by one or more deployed honeypots in response to a ransomware attack. Honeypot deployment controller 206, based on data 224, may adapt and redeploy the now-updated honeypot(s) in real time. The effectiveness of the redeployed honeypot(s) in luring ransomware attacks and in analyzing evolving ransomware tactics is enhanced by the updating the honeypot(s) in real time based on data 224.

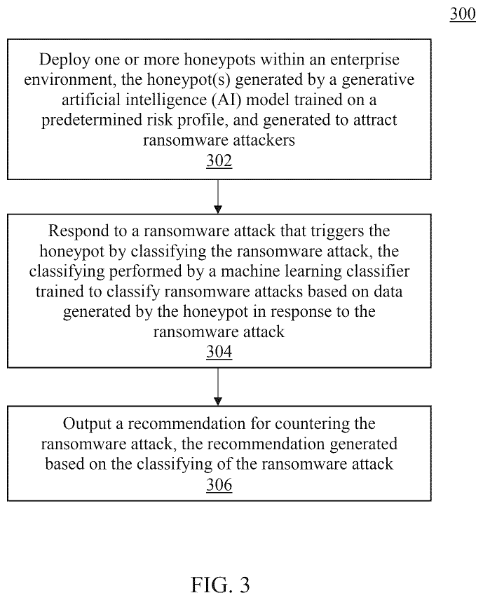

FIG. 3 is a flow diagram of method 300, which is a method for deploying one or more honeypots to attract a ransomware attack and for analyzing data generated by the honeypot(s) in response to a ransomware attack, according to at least one embodiment of the present disclosure. It will be readily appreciated that not every method step set forth in this flow diagram is always necessary, and that certain steps of the method may be combined, performed simultaneously, in a different order, or perhaps omitted, without varying from the scope of the disclosure. Method 300 may be implemented in a system such as HDTA framework 200 as described above with reference to FIGS. 1 and 2.

At block 302, the system deploys one or more honeypots within an enterprise environment. The honeypot(s) may be generated by a generative AI model trained on a predetermined risk profile. The honeypot(s) are generated to attract ransomware attackers.

At block 304, the system responds to a ransomware attack that triggers the honeypot(s). The system responds by classifying the ransomware attack. The classifying is performed by a machine learning classifier, which is trained to classify ransomware attacks based on data generated by the honeypot(s) in response to the ransomware attack,

At block 306, the system outputs a recommendation for countering the ransomware attack. The recommendation is generated based on the classifying of the ransomware attack.

In certain embodiments, method 300 includes generating the predetermined risk profile based on a select set of data generated in response to prior ransomware attacks. The risk profile may be an industry-specific risk profile. The recognizing of the behavioral patterns may be performed by a machine learning model. The machine learning model may be trained to a corpus of data corresponding to ransomware attacks.

Method 300, in certain embodiments, includes training the generative AI model through supervised learning with compiled data extracted from the risk profile. The compiled data may include execution logs, payload signatures, and/or attack sequences corresponding to each of the previous ransomware attacks.

In certain embodiments, method 300 may include generating the honeypot by prompting the generative AI model. The prompting may prompt the generative AI model to generate a honeypot that includes a deceptively realistic false file system and credentials, a simulated network environment, and/or vulnerabilities that mimic high-value assets of the enterprise environment.

Method 300, in certain embodiments, may include generating multiple different honeypots for deployment at different locations within the enterprise environment. The different locations may be selected based on the predetermined risk profile generated by recognizing behavioral patterns by the machine learning model. The different locations may include a perimeter of a network with the enterprise environment, an internal location within the network, a location within a demilitarized zone (DMZ) of the network, and/or a cloud-based location.

In certain embodiments, method 300 may include classifying the ransomware attack based in part on a combination of which of multiple honeypots were triggered and a sequence in which each was triggered in response to the ransomware attack.

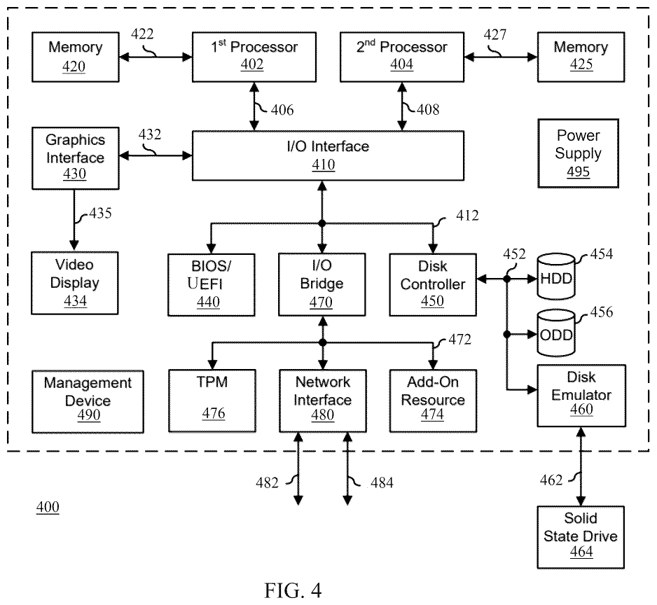

FIG. 4 shows a generalized embodiment of an information handling system 400 according to an embodiment of the present disclosure. Information handling system 400 may be the same or substantially similar to an information handling system configured to implement HDTA framework 200, described above with reference to FIGS. 1 and 2. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable mediums for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

That which is claimed is:

1. A system, comprising:
a honeypot deployment controller configured to deploy a honeypot within an enterprise environment, wherein the honeypot is generated by a generative artificial intelligence (AI) model trained on a predetermined risk profile, and wherein the honeypot is generated to attract ransomware attacks;
a ransomware threat analyzer communicatively coupled with the honeypot deployment controller, wherein the ransomware threat analyzer is configured to respond to a ransomware attack by classifying the ransomware attack and generating a recommendation based on the classifying; and
a security management interface communicatively couples the ransomware threat analyzer with a security management system of the enterprise environment, wherein the security management interface is configured to convey the recommendation to the security management system.

2. The system of claim 1, wherein the ransomware threat analyzer performs the classifying by implementing a machine learning classifier trained to classify the ransomware attacks based on data generated by the honeypot in response to the ransomware attacks.

3. The system of claim 1, further comprising:
a ransomware behavior classifier communicatively coupled with the honeypot deployment controller,
wherein the ransomware behavior classifier is configured to generate the predetermined risk profile based on a select set of data generated in response to a plurality of prior ransomware attacks.

4. The system of claim 3, wherein the ransomware behavior classifier performs a recognizing ransomware behavioral patterns by implementing a machine learning model trained to perform pattern recognition, and wherein the machine learning model is trained on a corpus of data corresponding to ransomware attacks.

5. The system of claim 3, further comprising:
an adaptive honeypot generator coupled with the ransomware behavior classifier, wherein the adaptive honeypot generator is configured to train the generative AI model based on the predetermined risk profile.

6. The system of claim 5, wherein the adaptive honeypot generator is configured to train the generative AI model through supervised learning with compiled data extracted from the risk profile.

7. The system of claim 5, wherein the adaptive honeypot generator is configured to generate the honeypot in response to prompting the generative AI model.

8. The system of claim 1, wherein the honeypot deployment controller is configured to deploy the honeypot along with a plurality of additional honeypots to different locations within the enterprise environment, wherein the different locations are selected by the honeypot deployment controller based on the predetermined risk profile.

9. The system of claim 8, wherein the ransomware threat analyzer is configured to classify a ransomware attack based in part on a combination of which of the honeypot and the plurality of additional honeypots were triggered and a sequence in which each was triggered in response to a ransomware attack.

10. The system of claim 1, further comprising:
a deception feedback module communicatively coupled with the honeypot deployment controller,
wherein the deception feedback module is configured to feedback to the honeypot deployment controller data generated by the honeypot in response to a ransomware attack, and wherein the honeypot deployment controller is configured to adapt and redeploy the honeypot in real-time based on the data.

11. A method, comprising:
deploying a honeypot within an enterprise environment, wherein the honeypot is generated by a generative artificial intelligence (AI) model trained on a predetermined risk profile, and wherein the honeypot is generated to attract ransomware attackers;
responsive to a ransomware attack triggering the honeypot, classifying the ransomware attack by a machine learning classifier trained to classify ransomware attacks based on data generated by the honeypot in response to the ransomware attack; and
outputting a recommendation for countering the ransomware attack, wherein the recommendation is generated based on the classifying.

12. The method of claim 11, further comprising:
generating the predetermined risk profile based on recognizing ransomware behavioral patterns in a select set of data generated in response to a plurality of prior ransomware attacks,
wherein the recognizing is performed by a machine learning model trained to recognize ransomware behavioral patterns, and wherein the machine learning model is trained on a corpus of data corresponding to ransomware attacks.

13. The method of claim 12, further comprising:
training the generative AI model through supervised learning with compiled data extracted from the risk profile,
wherein the compiled data includes at least one of execution logs, payload signatures, and attack sequences corresponding to each of the plurality of prior ransomware attacks.

14. The method of claim 11, further comprising:
generating the honeypot by prompting the generative AI model,
wherein the prompting prompts the generative AI model to generate a honeypot that comprises a deceptively realistic false file system and credentials, a simulated network environment, and vulnerabilities that mimic high-value assets of the enterprise environment.

15. The method of claim 11, further comprising:
generating a plurality of different honeypots for deployment at different locations within the enterprise environment.

16. The method of claim 11, further comprising:
deploying the plurality of different honeypots at the different locations, wherein the different locations are selected based on the predetermined risk profile.

17. The method of claim 16, wherein the different locations include at least one of a perimeter of a network with the enterprise environment, an internal location within the network, a location within a demilitarized zone (DMZ) of the network, and a cloud-based location.

18. The method of claim 16, wherein the classifying the ransomware attack is based, at least in part, on a combination of which of the honeypot and the plurality of different honeypots were triggered and a sequence in which each was triggered in response to the ransomware attack.

19. The method of claim 11, wherein the predetermined risk profile is an industry-specific risk profile.

20. An information handling system, comprising:
a processor; and
a memory coupled to the processor, the memory having program instructions stored thereon that, upon execution by the processor, cause the information handling system to perform operations including:
generating a predetermined risk profile based on recognizing ransomware behavioral patterns in a select set of data generated in response to a plurality of prior ransomware attacks, wherein the recognizing is performed by a machine learning model trained to recognize ransomware behavioral patterns, and wherein the machine learning model is trained on a corpus of data corresponding to ransomware attacks;
training a generative AI model through supervised learning with data extracted from the predetermined risk profile;
deploying a plurality of honeypots at different locations within an enterprise environment, wherein the honeypots are generated by a generative artificial intelligence (AI) model, and wherein the honeypots are generated to attract ransomware attackers;
responsive to a ransomware attack triggering the honeypots, classifying the ransomware attack by a machine learning classifier trained to classify ransomware attacks based on data generated by the honeypots and on a combination of which of the plurality of honeypots were triggered and a sequence in which each was triggered in response to the ransomware attack; and
outputting a recommendation for countering the ransomware attack, wherein the recommendation is generated based on the classifying.
